(19) United States
(12) Patent Application Publication
(10) Pub. No.: US 2025/0187900 A1
(43) Pub. Date: Jun. 12, 2025

(54) APPARATUS FOR VACUUM-FILLING A HEAT EXCHANGER WITH FLUID AND METHOD OF USING

(71) Applicant: Joshua Morgan, Stillwater, MN (US)

(72) Inventor: Joshua Morgan, Stillwater, MN (US)

(21) Appl. No.: 18/924,786

(22) Filed: Oct. 23, 2024

Related U.S. Application Data
(60) Provisional application No. 63/592,436, filed on Oct. 23, 2023.

(51) Int. Cl. B67D 7/72; B60S 5/00; B67D 7/02

(52) U.S. Cl. CPC B67D 7/725; B67D 7/0277; B60S 5/00

(57) ABSTRACT

A device adapted for vacuum-filling a coolant system, and a method of using a device adapted for vacuum-filling a coolant system.

### CROSS-REFERENCE TO RELATED APPLICATION

The present disclosure claims the benefit of U.S. Provisional Application No. 63/592,436, filed Oct. 23, 2023, which is hereby fully incorporated by reference in its entirety.

### TECHNICAL FIELD

The present invention relates to fluid fill systems. In particular, the present invention relates to an assembly for vacuum-filling a heat exchanger with fluid.

### BACKGROUND

Following the performance of maintenance on an internal combustion engine's cooling system of, one method of refilling the system with coolant involves drawing a vacuum on the system and then allowing coolant to be sucked into the liquid cooling system through a suction tube having an inlet that is positioned near the bottom of a supply reservoir. This involves the manipulation of valves by a technician while simultaneously holding the suction tube in the supply reservoir, maintaining the inlet to the suction tube below the level of the coolant in the supply reservoir, and maintaining the supply reservoir upright. This operation is typically a one-person task, requiring the technician to manipulate the valves with one hand while positioning the suction tube with the other hand. If the inlet to the suction tube is not continuously maintained below the level of the coolant in the supply reservoir, the vacuum in the coolant system can be broken, requiring the process to be repeated. Moreover, the supply reservoir is prone to tipping over, allowing the coolant to spill from it. In some situations, the supply reservoir is positioned within or near the vehicle's engine cavity, thereby increasing the likelihood of a spill occurring.

Despite the wide use of the aforementioned method in the internal combustion maintenance industry, there exists an unfulfilled need for a device that aids a technician in vacuum-filling a coolant system by positioning the inlet to a suction tube below the level of the coolant in the supply reservoir while also preventing coolant from spilling from the supply reservoir if it is inadvertently tipped sideways.

### SUMMARY

According to one embodiment of the present disclosure, a device adapted for vacuum-filling a coolant system.

According to another embodiment of the present disclosure, a method of using a device adapted for vacuum-filling a coolant system.

### BRIEF DESCRIPTION OF THE DRAWINGS

The accompanying drawings, which are incorporated in and constitute a part of this specification, together with a general description of the invention given above, and the detailed description of the embodiments below, serve to explain the principles of the invention.

FIG. 1 is a schematic diagram showing apparatus of the prior art for vacuum- filling a coolant system.

FIG. 2 is a schematic diagram showing a device for vacuum-filling a heat

exchanger of the present invention.

FIG. 3 is a schematic diagram showing the schematic diagram shown in FIG. 2, also identifying the directions of fluid flow.

FIG. 4 is an illustration showing the device for vacuum-filling a heat exchanger attached to a cooling system of an internal combustion engine.

FIG. 5A shows the standpipe assembly and supply reservoir of the device for vacuum-filling a heat exchanger shown in FIG. 4.

FIG. 5B shows an alternative embodiment of the makeup air inlet port on the supply reservoir shown in FIG. 5A.

FIG. 6A shows the standpipe assembly removed from the supply reservoir shown in FIG. 4.

FIG. 6B shows the rigid pipe of the standpipe assembly shown in FIG. 6A.

FIG. 7A shows an underside view of the cap and standpipe assembly shown in FIG. 4.

FIG. 7B shows the cap portion of the standpipe assembly shown in FIG. 4.

FIG. 7C shows the cap, inlet cutout valve, and female portion of the quick connect fitting of the standpipe assembly shown in FIG. 4.

FIG. 7D shows the inlet cutout valve of the standpipe assembly shown in FIG. 4.

FIG. 7E shows two washers on standpipe assembly shown in FIG. 4.

FIG. 7F shows several ¼-inch female to ¼-inch female NPT fittings.

FIG. 7G shows an exploded view of a ½-inch push-to-connect quick connect fitting view showing the internal structure.

FIG. 7H shows two exemplary push-to-connect quick connect fittings of different sizes, each connected to a respective standpipe.

FIG. 71 shows perspective views of ½inch push-to-connect quick connect fitting with ¼-inch male NPT on its opposite end.

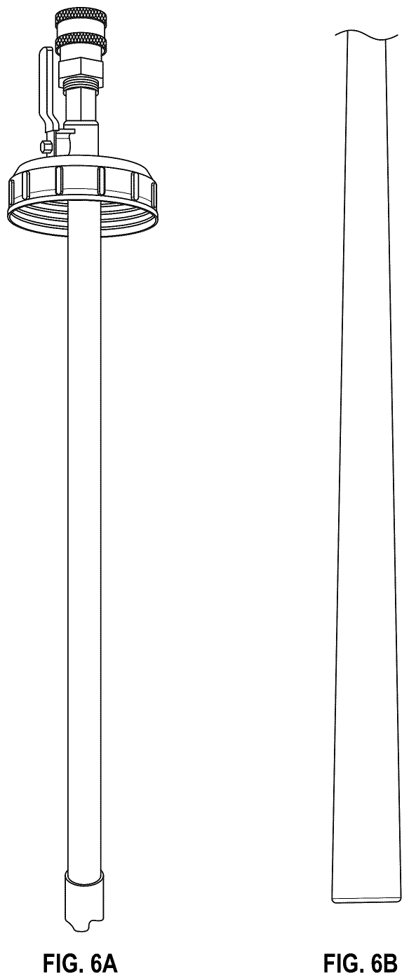

FIG. 8A is a bottom view of the standpipe strainer inlet assembly shown in FIG. 6A.

FIG. 8B is a side view of the standpipe strainer inlet assembly shown in FIG. 6A, positioned within an outside caliper measuring tool.

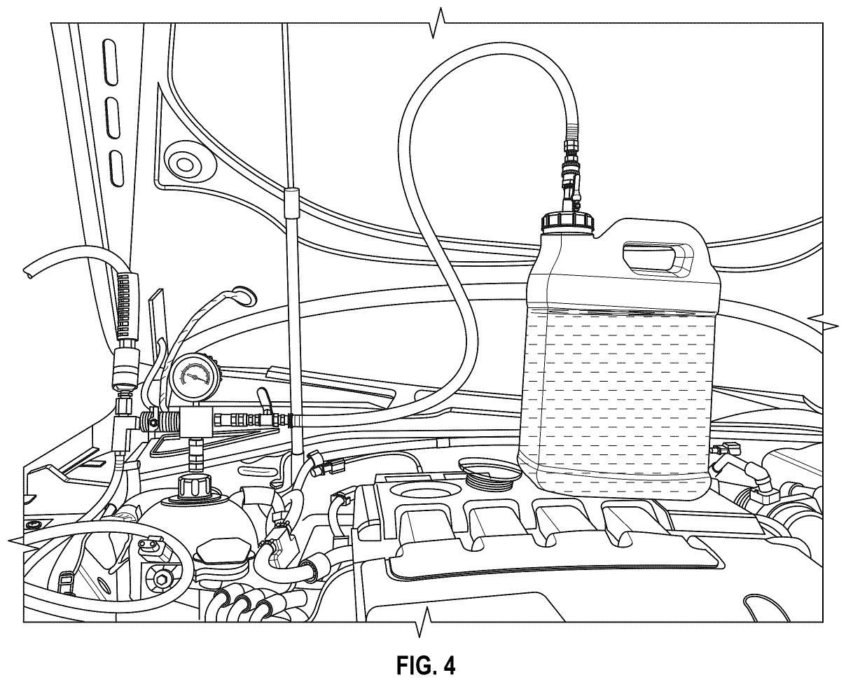

FIG. 9A shows the supply reservoir transfer tube shown in FIG. 4.

FIG. 9B shows the air eductor air eductor, manifold, and coolant expansion reservoir adapter shown in FIG. 4.

FIG. 9C is a second view of the supply reservoir transfer tube shown in FIG. 9A.

FIG. 9D shows the supply reservoir transfer tube connector and male portion of the quick connect fitting of the supply reservoir transfer tube shown in FIG. 9A.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

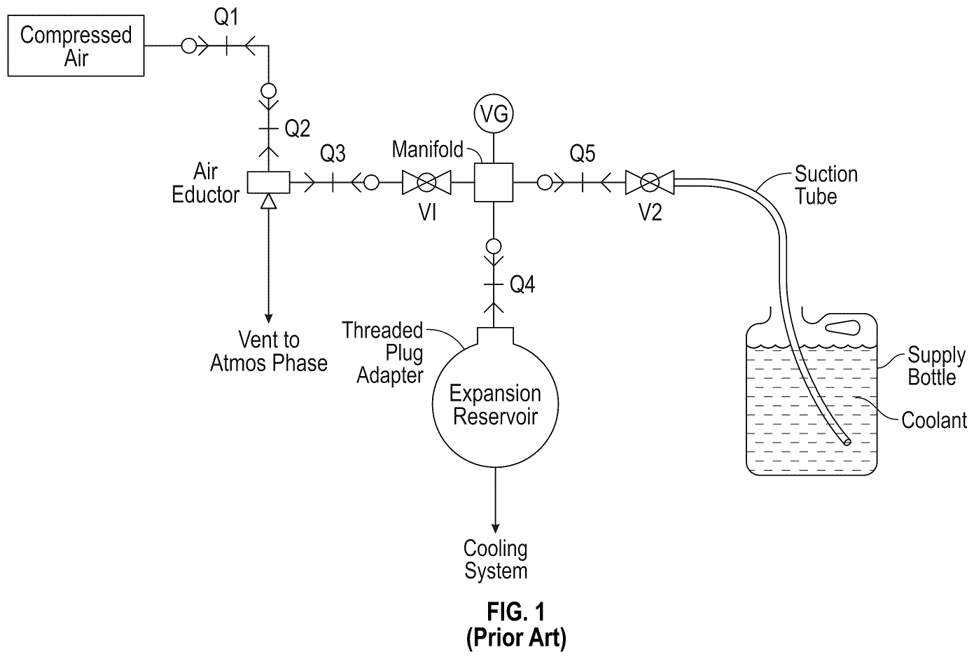

FIG. 1 is a schematic diagram showing an assembly of the prior art for vacuum-filling a coolant system. Shown in FIG. 1 are coolant vacuum fill apparatus, shop compressed air supply, quick connect fitting Q1 attaching compressed air to air hose, quick connect fitting Q2 attaching air hose to air eductor, vent hose for venting discharge air from air eductor to atmosphere, quick connect fitting Q3 attaching vacuum port on air eductor to valve V1 attached to manifold, vacuum gauge VG on manifold, quick connect fitting Q4 attaching vacuum hose to threaded adaptor attached to expansion reservoir on the cooling system of an internal combustion engine, quick connect fitting Q5 attaching manifold to valve V2, and suction tube placed through the mouth opening of a supply bottle partially filled with coolant. Valves V1 and V2 are both 90 deg (quarter-turn) ball valves that are used to seal the system after a vacuum is drawn on the coolant system. Vacuum gauge VG is calibrated to indicate a vacuum that ranges from zero (atmospheric pressure) to 30 inches Hg (hard vacuum). Manifold is a four-port manifold configured so that Vacuum gauge VG, valve V1, quick connect fitting Q4, and quick connect fitting Q5 are attached to its respective ports. Valve V2 is also used to create a flow path between the coolant in supply bottle via suction tube to threaded plug adapter attached to expansion reservoir and into expansion reservoir. Suction tube is clear flexible PVC tubing.

The coolant system vacuum fill assembly shown in FIG. 1 is used to refill the cooling system on an internal combustion engine with coolant following maintenance on the cooling system that had been at least partially drained of coolant prior to or during the maintenance. During operation of this coolant system vacuum fill assembly, an internal combustion engine technician (hereafter, technician) connects the assembly as shown in FIG. 1. Valves V1 and V2 are closed. The flow of shop compressed air is initiated to air eductor, and the technician opens valve V1, thereby allowing a vacuum to be drawn on cooling system. Shop compressed air is typically about 180 psi but can range from about 100-400 psi. The technician monitors the vacuum on the cooling system by observing vacuum gauge VG, continuing until the vacuum level reaches the desired level. Typically, nearly a full vacuum (hard vacuum) is drawn, having an indication of about 30 inches Hg (762 mm Hg) on vacuum gauge VG. Next, the technician closes valve V1 and then discontinues supplying shop compressed air to air eductor. With the desired vacuum having been established on the cooling system, the technician holds suction tube in supply bottle so that the suction tube end is submerged in coolant in supply bottle. The technician must use care to maintain suction tube end submerged in coolant to avoid breaking the vacuum during the filling operation. The technician must also use care to prevent tipping supply bottle, which could allow coolant to drain from it through its open mouth. Finally, the technician opens valve V2, allowing coolant to be sucked through suction tube via manifold into expansion reservoir until coolant system has been refilled as indicated by a desired level of coolant in expansion reservoir. The technician then closes valve V2, breaks vacuum by opening valve V1, and removes coolant system vacuum fill assembly.

As noted above, if supply bottle is not held upright and suction tube is not held submerged in coolant, vacuum in coolant system can be inadvertently broken. In this case, the technician must reperform the above steps to properly refill coolant system.

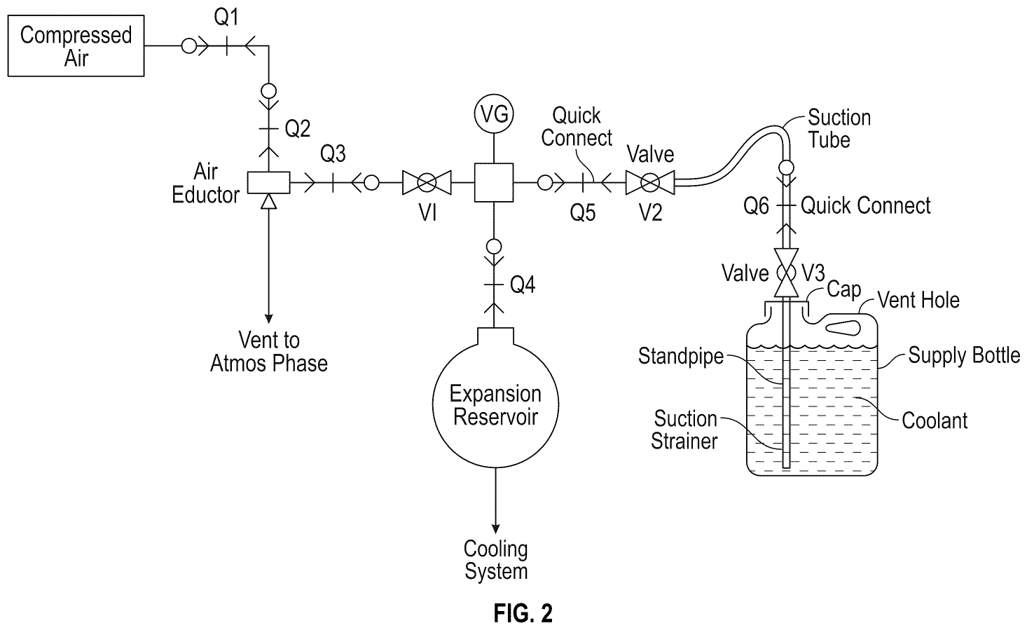

FIG. 2 is a schematic diagram showing apparatus for vacuum-filling a heat exchanger of the present invention. Shown in FIG. 2 are shop compressed air supply, quick connect fitting Q1, air hose, quick connect fitting Q2, air eductor, vent hose, quick connect fitting Q3, valve V1, manifold, vacuum gauge VG, quick connect fitting Q4, threaded adaptor, expansion reservoir on the cooling system of an internal combustion engine, and quick connect fitting Q5, all having a description substantially similar to that provided above in regard to FIG. 1.

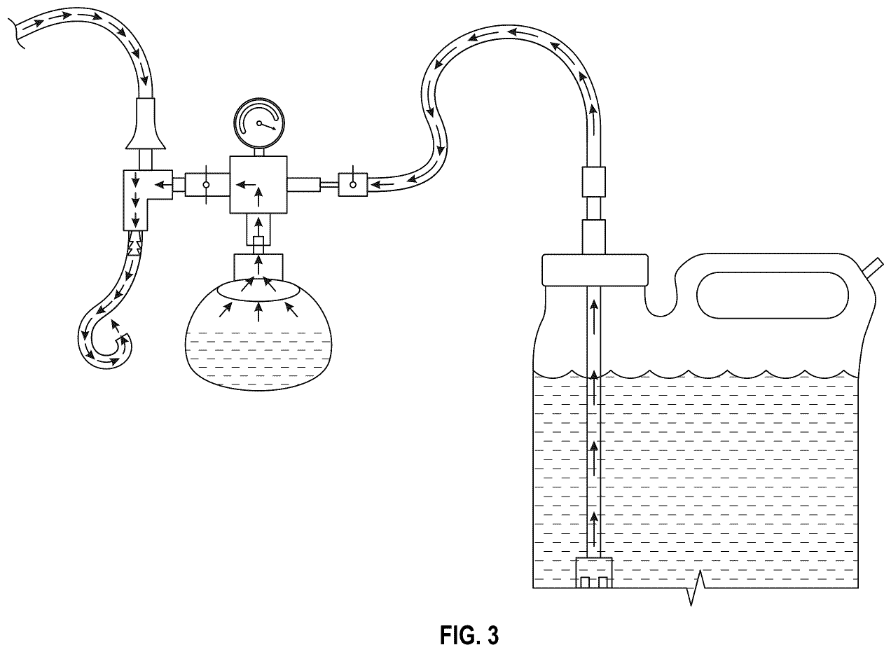

Also shown in FIG. 2 are valve V2, suction tube, quick connect fitting Q6, valve V3, standpipe, suction strainer, supply bottle, coolant, supply bottle cap, and vent hole. Valve V2 is attached to one end of suction tube, and the inner end of quick connect fitting Q6 is attached to the other end of suction tube. The inner end of quick connect fitting Q6 is attached to valve V3 which passes through an aperture on cap and is attached to standpipe. Valves V2 and V3 are both 90 deg (quarter-turn) ball valves. Suction strainer is at the end of standpipe. Supply bottle cap is configured to screw on to supply bottle by mating threads. A vent hole, or aperture, is located at or near the top of supply bottle. The length of standpipe is established to position suction strainer at or near the bottom of supply bottle when supply bottle cap is threaded on to supply bottle. As shown, supply bottle contains coolant which will be drawn into cooling system during the operation of this device for vacuum-filling a heat exchanger. Valve V2, suction tube, quick connect fitting Q6, valve V3, standpipe, suction strainer, supply bottle, supply bottle cap, and vent hole will be shown and described in more detail below, in FIGS. 3-4, 5A-5B, 6A-6B, 7A-7E, 6A-8B, and 9A-9D.

During operation of this device for vacuum-filling a heat exchanger, a technician draws a vacuum in coolant system using a process that is substantially similar to that described above in regard to FIG. 1. As noted earlier, valves V1 and V2 are both closed after the desired vacuum exists on cooling system as indicated on vacuum gauge VG. A desired vacuum is about 30 in. Hg (762 mm Hg) as indicated on vacuum gauge. Next, a leak test on cooling system is performed by monitoring vacuum gauge VG. The vacuum reading holding relatively constant is an indication that a leak does not exist. Upon noting that a system leak does not exist, valve V2 is opened, and coolant is drawn in from supply bottle. The technician will have positioned supply bottle such that it stands upright or nearly upright, whether it be on the floor beside the vehicle on which cooling system is located, on a stand beside the vehicle, or within the engine compartment of the vehicle. Next, the technician opens (or checks open) valve V3, and then opens valve V2, thereby allowing coolant in supply bottle to be drawn into expansion reservoir and into cooling system with a flow path through suction strainer, standpipe, valve V3, quick connect fitting Q6, suction tube, quick connect fitting Q5, manifold, and quick connect fitting Q4. As coolant is drawn into cooling system, ambient air is drawn into supply bottle through vent hole to maintain the interior of supply bottle at or near ambient atmospheric pressure. This described vacuum fill process is typically a preferred process for filling a cooling system, (i.e., heat exchanger) ton an internal combustion engine because it minimizes or prevents air from being trapped in cooling system which can have adverse effects. For example, a volume of air that is trapped in cooling system can allow the internal combustion engine to overheat from a lack of proper heat removal.

FIG. 3 is a schematic diagram showing the schematic diagram shown in FIG. 2, also identifying the directions of fluid flow. The components and features shown in FIG. 3 are substantially similar to those shown and described above in regard to FIG. 2, with the following additional features: barbed fitting is threaded ono the inner end of quick connect fitting Q6, vent fitting replaces vent hole on supply bottle, and supply bottle has a capacity of about 2.5 gal (9.5 liter).

FIG. 4 is an illustration showing the device for vacuum-filling a heat exchanger attached to a cooling system of an internal combustion engine. The components shown in the illustration of FIG. 4 depict the relative shapes and sizes of those shown above in FIG. 2. Threaded plug adapter has outer threads is shown engaged with inner threads on expansion reservoir. Threaded plug adapter (also called cap) is one of many caps included in the manifold tool kit for use in attaching to cooling system. Suction tube is clear flexible plastic having an OD of 0.384 in. (9.75 mm), ID of 0.274 in. (6.26 mm), and length of about 36 in. (91 cm). The end of suction tube with valve V2 is configured to attach to manifold. the tool. The other end of suction tube is attached via a threaded barb fitting to the inner end of quick connect fitting Q6, with the inner end of quick connect fitting Q6 threaded onto the downstream end of valve V3, and a threaded barb fitting is threaded onto the upstream end of valve V3. In the configuration shown, quick connect fitting Q6 is the type that is commonly used on a pressure washer discharge hose, and threaded barb fittings are ¼ in. (6.35 mm) brass hose barb fittings. The configuration is not limited to the components shown. For example, any type and/or size of valves can be used, and any type and/or size of suction tubing can be used. Also, any size and type of supply bottle cap can be used, with the expectation that it is configured to be threadedly attached to an associated supply bottle. Moreover, and size, shape, and/or capacity of supply bottle can be used.

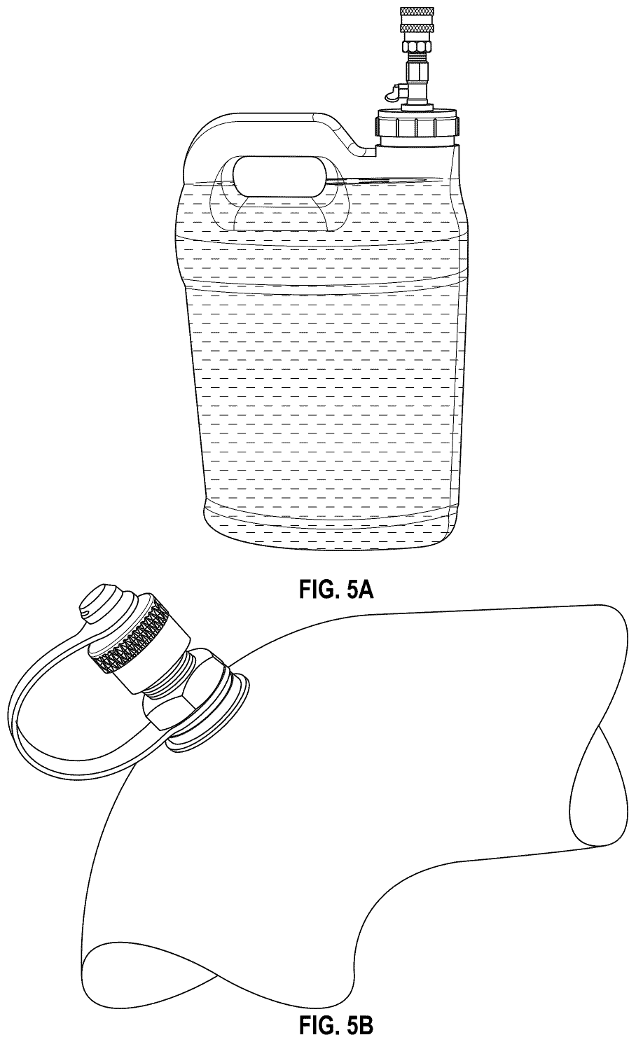

FIG. 5A shows the standpipe assembly including valve V3 and the outer end of quick connect fitting Q6. In the embodiment shown, vent hole is located in a region on the handle of supply bottle. In other embodiments, it could be located anywhere in the upper region of supply bottle. Vent hole can have a diameter from about 1/32 inch (0.8 mm) to ¼ inch (6.4 mm). In other embodiments, and size vent hole can be used, and more than one vent hole can be used.

FIG. 5B shows the detail of vent fitting (breather valve). As shown, vent fitting has a threaded removable cap that is supported by retainer strap when threaded removable cap is removed from vent fitting. Vent fitting is a ¼-inch size breather valve and is installed in a ¼ inch (6.4 mm) aperture in supply bottle. Retainer strap helps prevent the loss of threaded removable cap. An advantage of using vent fitting as opposed to vent hole shown in FIG. 2 is that coolant in supply bottle can be completely contained when transporting or storing supply bottle containing coolant when supply bottle is detached from quick connect fitting Q6. This helps prevent leakage of coolant from supply bottle as may otherwise occur when coolant sloshes about while handling supply bottle, or if supply bottle were to be toppled sideways. Vent fitting can be installed anywhere in the upper region of supply bottle and can be constructed of any material, with nonlimiting examples being brass, aluminum, steel, stainless steel, other metals or alloys thereof, plastic, or a composite material.

Supply bottle is a 2.5 gallon (9.5 liter) F-style plastic bottle (commonly referred to as a “2.5 gal CSBD F-style bottle”, with CSBD being the name of the manufacturer. Supply bottle is made of translucent High Density Polyethylene (HDPE), which has an advantage of strength, durability, light weight, and being able to see a fluid level from the outside. In other embodiments, supply bottle can have any capacity that can be considered suitable for the size cooling system being refilled, and the volume of coolant that must be used to refill cooling system. If supply bottle has a relatively large capacity it can be referred to as a supply tank. A typical range of sizes for supply bottle is from about 1 pint (0.47 liter) to 50 gallons (189 liters) but can be smaller or larger than this in some embodiments. In other embodiments, supply bottle can be clear, opaque, or with any range of light transmission there between, and can be made of any type of plastic, metal, composite, or any other material that can be configured to contain fluid.

FIG. 6A shows the standpipe assembly removed from the supply reservoir shown in FIG. 4. FIG. 6B shows the rigid pipe of the standpipe assembly shown in FIG. 6A. Standpipe has a length that is chosen to place suction strainer touching or within the vicinity of the bottom of supply bottle. In the illustrated embodiment (i.e., using a 2.5 gal CSBD F-style bottle), standpipe is made of Cross-Linked Polyethylene (PEX) and is referred to as “½-inch PEX”, having an outer diameter (OD) of about 0.627 inch (1.6 cm), an inner diameter (ID) of about 0.47 inch (1.2 cm), and a length of about 13 inches long (33 cm). PEX has the advantage of being fairly rigid while also having the strength that allows it to be threaded. Suction strainer is made of brass (will be shown and described later in FIGS. 8A-8B). In some embodiments, standpipe can have any OD ranging from about ⅛ inch (3.2 mm) to 1 inch (2.5 cm) with a corresponding ID, and any length ranging from about 2 inch (5 cm) to about 10 feet (3 m) but the OD, ID, and/or length can be outside of these ranges. In other embodiments, standpipe can be made of any material with nonlimiting examples being Polyvinyl Chloride (PVC), HDPE, or other plastics; brass copper, or other metals; or composite materials. In yet other embodiments, standpipe can be used without a suction strainer at the bottom end. In these embodiments, standpipe can be configured to stop a short distance from the bottom of supply bottle. In other configurations, the bottom end of standpipe can be cut at an angle or any irregular shape that allows fluid flow into standpipe when any part of standpipe contacts the bottom of supply bottle.

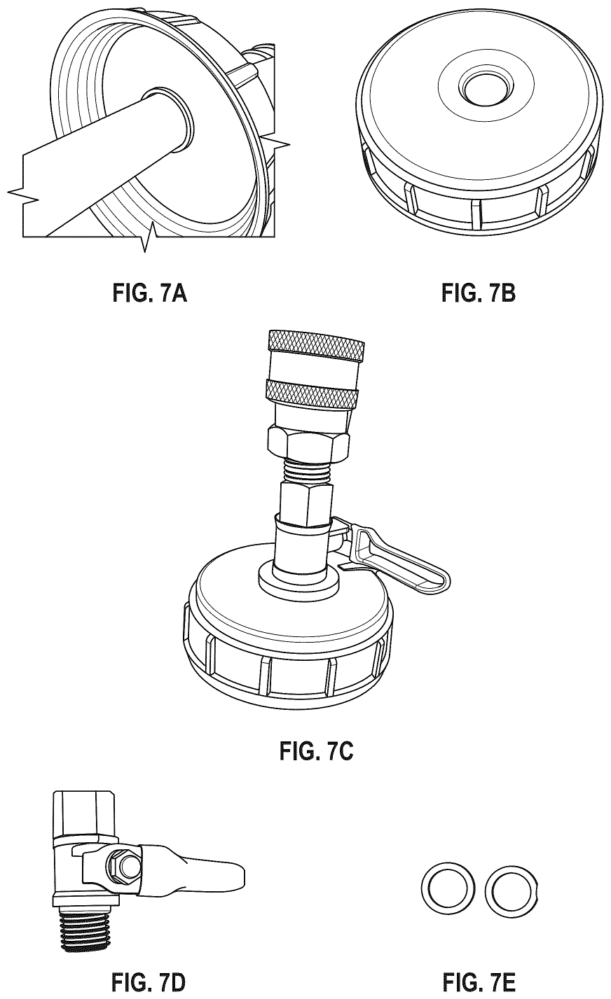

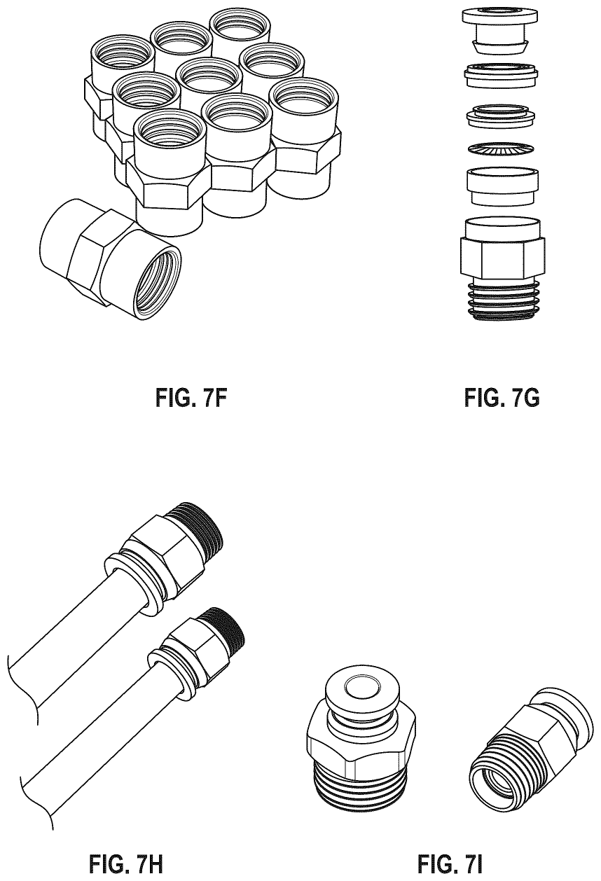

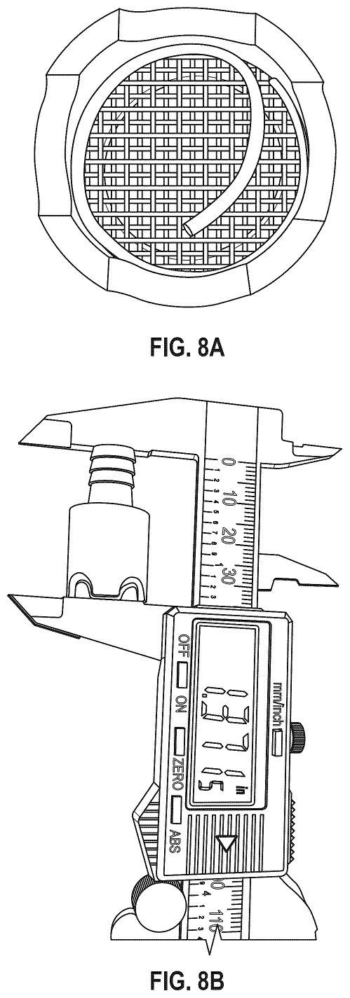

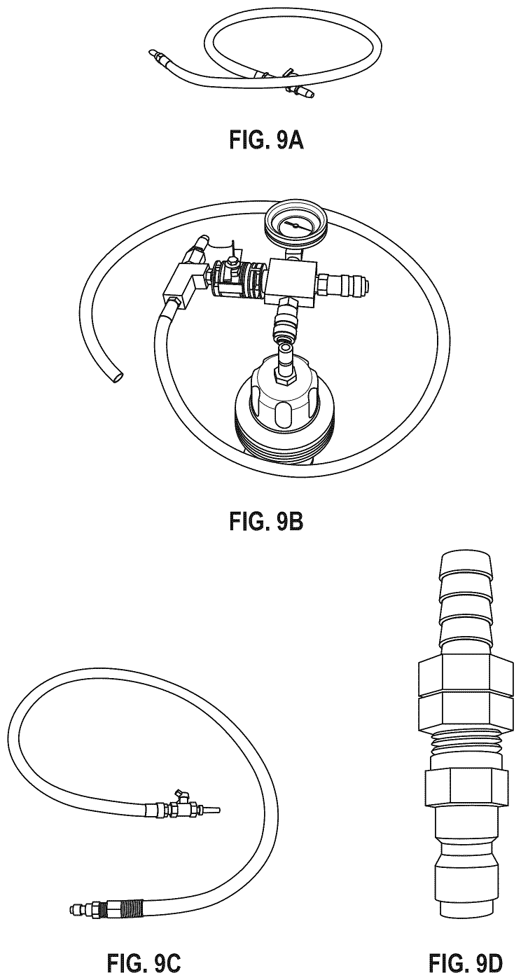

Referring again to FIG. 6A, standpipe assembly includes a ¼ turn ball valve (V3 as shown in FIG. 2) that is connected to the outer end of quick connect fitting Q6. This upper portion of standpipe assembly will be shown and described later in FIGS. 7A-7E.

FIG. 7A shows an underside view of the cap and standpipe assembly shown in FIG. 4. FIG. 7B shows the cap portion of the standpipe assembly shown in FIG. 4. FIG. 7C shows the cap, inlet cutout valve, and female portion of the quick connect fitting of the standpipe assembly shown in FIG. In the illustrated embodiment, a nylon washer is used against the top of the cap. FIG. 7D shows the inlet cutout valve of the standpipe assembly shown in FIG. 4. FIG. 7E shows two washers, one or both of which may be used on standpipe assembly shown in FIG. 4. FIGS. 7A-7E will be described together.

Standpipe passes through aperture in cap as shown in FIGS. 7A-7B and is threadedly attached to internal structure of inlet cutout valve shown in FIGS. 7C-7D. The upper end of standpipe is threaded with ½-inch pipe thread (½×20 NF tap) that will allow it to be threaded into the bottom of inlet cutout valve, with the possible use of thread tape or pipe compound. Aperture (i.e., port or hole) in cap has a diameter of about 0.627 inch (1.6 cm), or any other diameter that is selected to accommodate standpipe OD. Inlet cutout valve V3 is attached to cap by threadedly engaging with periphery of aperture on cap. The end of the threaded portion of inlet cutout valve is shown in FIG. 7A. In the illustrated embodiment, external threads on inlet cutout valve create corresponding threads on periphery of aperture. In some embodiments, threads on periphery of aperture on cap can be created with an appropriately sized thread-cutting tap prior to threadedly attaching inlet cutout valve V3 to cap. In other various embodiments, aperture in cap can have a diameter that ranges from about ⅛ inch (3 mm) to 6 inches (15 cm). In some embodiments, a barbed fitting could be used to attach standpipe to valve V3.

Referring again to FIG. 7C, a washer is placed between the bottom shoulder of inlet cutout valve V3 and the top of cap (not visible in FIG. 7C). In some embodiments, washers can be made of any material, with other methods being used for attaching standpipe to cap. In other embodiments, standpipe can be held in place at the bottom of cap with a thread nut. In some embodiments, one or both washers can be eliminated. In yet other embodiments, standpipe can be adhesively attached to cap, or standpipe and cap can be molded or manufactured as a single assembly. Nonlimiting examples of manufacturing include molding, extruding, additive manufacturing, and hybrid additive manufacturing.

FIG. 7F shows several ¼-inch female to ¼-inch female NPT fittings. FIG. 7G shows an exploded view of a ½-inch push-to-connect quick connect fitting showing the internal structure. FIG. 7H shows two exemplary push-to-connect quick connect fittings of different sizes, each connected to a respective standpipe. FIG. 71 shows perspective views of ½ inch push-to-connect quick connect fitting with ¼-inch male NPT on its opposite end. FIGS. 7F-71 will be described together, together describing various alternative embodiments of connecting inlet cutout valve to standpipe. ¼-inch female to ¼-inch female NPT fitting shown in FIG. 7F can be used to threadedly couple inlet cutout valve to ½-inch push-to-connect quick connect fitting.

In an alternative embodiment, a method of attaching the standpipe to the cap is to use a push-to-connect quick connect fitting shown in FIGS. 7G-71 that grips standpipe, with the other end being threaded to attach to inlet cutout valve. In this embodiment, standpipe attaches to 1/2-inch push-to-connect quick connect fitting by pushing upper end of standpipe into ½-inch push-to-connect quick connect fitting, thereby locking standpipe in place while forming a leak-proof or leak-resistant seal. An advantage of the aforementioned configuration is that it can provide structural strength, durability, and service life.

In other embodiments, standpipe OD and corresponding push-to-connect quick connect fitting can have a size ranging from ⅛-inch OD to 1-inch OD, or larger. In various embodiments standpipe can be made of any ridged material with nonlimiting examples including as PVC, other plastic, and any metal or metal alloy so long as push-to-connect quick connect fitting is sized to correspond to standpipe OD.

FIG. 8A is a bottom view of the standpipe strainer inlet assembly shown in FIG. 6A. FIG. 8B is a side view of the standpipe strainer inlet assembly shown in FIG. 6A, positioned within an outside caliper measuring tool. Strainer inlet assembly can also be called a strainer inlet or a suction strainer, having a wire mesh strainer secured by a spring retainer that filters particles and sediment from entering standpipe during operation. Strainer inlet has an outer diameter of about 0.705 inch (1.79 cm) and an overall length of about 1.37 inch (3.48 cm). The upper end of strainer inlet assembly is a barbed fitting for attachment to standpipe (as shown in FIG. 6A). This also adds to the durability of standpipe assembly and helps assure a secure attachment to standpipe. The barbed end has an OD of 0.404 inch (1.03 cm) and is wrapped by polytetrafluoroethylene (PTFE)) thread seal tape to further assure a secure attachment of strainer inlet to standpipe thereby making the fitting snug inside the PEX pipe. In some embodiments, other materials can be used to secure the barbed end within standpipe, with nonlimiting examples including other types of joint sealing tape, compound, or adhesive. In other embodiments, no additional sealing material is used on the barbed end. In any of these embodiments, standpipe strainer can be made of any material including brass, copper, aluminum, or other metals or alloys thereof, or of plastic, resin, or a composite material. In other embodiments, standpipe strainer can include other types of screens, grates, or filter elements, and can be made from any of the aforementioned materials.

Referring again to FIGS. 8A-8B, four flow channels or flow arches are located on the bottom of strainer inlet assembly, having the purpose of allowing flow into strainer inlet assembly in the event that strainer inlet assembly contacts or nearly contacts the bottom of supply bottle. In the illustrated embodiment, each arch has a width of about 0.3 inch (7.6 mm) and a center height of about 0.8 inch (20 mm). In other embodiments, any number of flow channels can be used, each having any shape and any dimension that can be accommodated by strainer inlet assembly. In some embodiments, one or more apertures of any shape or size can be located in the side of strainer inlet assembly (i.e., not along its bottom face), thereby allowing the bottom face of strainer inlet assembly to contact or nearly contact the bottom of supply bottle. In yet other embodiments, standpipe strainer can be provided without a strainer or filter element. In these embodiments, standpipe strainer can be referred to as a standpipe inlet component or a standpipe foot. In some embodiments, standpipe can be provided without standpipe strainer or standpipe inlet component, instead having a bare end that functions as the inlet port to standpipe. In these embodiments, the exposed standpipe end can optionally be cut at an angle, with a notch, or with some other pattern such that the cut cross-section it is not relatively flat and normal to the axis of standpipe. This can help prevent restricting coolant flow into standpipe during operation by contacting or nearly contacting the bottom of supply bottle.

FIGS. 9A and 9C show suction tube that was shown and described above in regard to FIGS. 2 and 4. Suction tube can also be referred to as supply reservoir transfer tube. FIG. 9B shows air eductor, manifold, and coolant expansion reservoir adapter shown and discussed above in regard to in FIG. 4. Manifold can be referred to as a four-way manifold, and it is known to those skilled in the internal combustion cooling system arts. FIG. 9D shows suction tube barbed end attached to the inner end of quick connect fitting Q6.

Those who are skilled in the internal combustion cooling system arts prefer drawing a vacuum on a cooling system by using an air eductor according to the above-described process as opposed to using a vacuum pump or other type of vacuum source.

Various embodiments of systems, devices, and methods have been described herein, with several non-exhaustive examples being provided. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims. For purposes of interpreting the claims, it is expressly intended that the provisions of 35 U.S.C. § 112(f) are not to be invoked unless the specific terms “means for” or “step for” are recited in a claim.

1. A new device adapted for vacuum-filling a heat exchanger, substantially as shown and described herein.

2. A method of using a new device adapted for vacuum-filling a heat exchanger. substantially as shown and described herein.
